(19) United States
(12) Patent Application Publication
(10) Pub. No.: US 2006/0204406 A1
(43) Pub. Date: Sep. 14, 2006

(54) Method for producing powder coatings and device for carrying out said method

(76) Inventors: Werner-Alfons Jung, Uhrwerkerstrasse (DE); Heinz-Peter Rink, Münster (DE); Vens Thomas, Velen (DE); Thomas Danner, Ludwigshafen (DE); Robert Bayer, Sinsheim (DE); Andreas Bauder, Mannheim (DE); Marian Mours, Weisenheim (DE)

Correspondence Address: BASF CORPORATION, 1609 BIDDLE AVENUE, WYANDOTTE, MI, 48192, US

(21) Appl. No.: 10/549,624

(22) PCT Filed: Mar. 9, 2004
(86) PCT No.: PCT/EP04/02394

§ 371 Date: Sep. 19, 2005

(30) Foreign Application Priority Data
Mar. 27, 2003 (DE) 103-13762.9

(51) Int. Cl. C08J 3/02; B01J 19/00

(52) U.S. Cl. 422/131; 427/212; 523/335; 526/74

(57) ABSTRACT

A process and means for producing powder coating materials. A polyaddition resin is prepared in a Taylor reactor at temperatures above the melting temperature of the polyaddition resin. The polyaddition resin melt prepared in a Taylor Reactor is supplied to a homogenizing means and crosslinker is added to the homogenizing means to prepare a components melt, followed by cooling the components melt on a cooling means for solidification to the end product and supplying the end product to a pulverizing means.

The present invention relates to a process for producing powder coating materials and to apparatus suitable for implementing said process.

It is known to prepare the solid resins used as binders of powder coating materials, preferably polyaddition resins, such as polyurethanes, polyepoxides or addition (co)polymers of olefinically unsaturated monomers, in a so called batch process or continuously.

In the case of the batch process first of all at least one monomer in solution in a solvent is (co)polymerized to form a polyaddition resin and in the subsequent stripping operation the polyaddition resin is freed at least substantially from the solvent. In the case of continuous preparation the monomers needed to prepare the polyaddition resin are supplied continuously to a reaction volume.

The polyaddition resin prepared in the batch process or continuously is brought to a temperature at which it becomes or remains a liquid melt and can be coextruded together with a crosslinker, where appropriate with the addition of further additives as well, such as light stabilizers. Following its solidification, the extrusion product is then finely ground to give the powder coating material.

Coating components using the powder coating material is carried out by depositing the powder—usually in an electrical field under electrostatic action—on the component. Subsequently at least the powder layer is heated to a crosslinking temperature, which is situated above the extrusion temperature and at which the coherent coating film forms from the powder layer by crosslinking.

It has now become apparent that, although the extrusion temperature is lower than the crosslinking temperature, unwanted precrosslinked particles are formed as early as during the extrusion operation. It has also proven difficult to add further additives such as light stabilizers, etc., during the extrusion process—but this is an indispensable step—depending on the desired properties of the powder coating material.

In order to reduce the fraction of precrosslinked particles EP 1 253 174 A1 proposes, with the aim of reducing the extrusion temperature, coextruding the crosslinker in a form in which it is dissolved at least 20% in a solvent with the resin and subsequently removing the solvent under a reduced pressure. The use of solvents, however, is a disadvantage, since they require additional safety expense and must be disposed of.

It is an object of the invention to provide a process, and apparatus suitable for implementing the process, with which the fraction of precrosslinked particles is reduced as compared with the prior art without the need to use solvents.

This object is achieved by the process reproduced in claim 1 and, in its constructional aspect, by the apparatus reproduced in claim 10.

The process of the invention comprises the following steps:
preparing a polyaddition resin melt using a Taylor reactor at a temperature above the melting temperature of the polyaddition resin;
supplying the polyaddition resin melt to a homogenizing means;
adding a crosslinker to the homogenizing means to prepare a components melt;
cooling the components melt for solidification to the end product;
pulverizing the end product.

The polyaddition resin melt, prepared in accordance with the invention using a Taylor reactor, is not placed on a cooling belt and cooled, as in the prior art, but instead is supplied without an interposed cooling step to an homogenizing means. Then the crosslinker—preferably in powder or liquid melt form—plus, if desired, at least one additive is admixed to the homogenizing means. Homogenization of the mixture is much better owing to the low viscosity of the polyaddition resin melt during the homogenizing operation.

A particularly favorable effect on the degree of homogenization results from the addition of the crosslinker likewise in liquid melt form. Since, in comparison with existing processes, the components melt need spend only a comparatively short time in the homogenizing means in order to reach a desired degree of homogenization, there is a reduction in the fraction of precrosslinked particles.

The crosslinker can be supplied to the homogenizing means in parallel to the polyaddition resin melt. The residence time of the crosslinker in the homogenizing means will then correspond to that of the polyaddition resin melt.

It is likewise possible, however, to supply the crosslinker to the polyaddition resin melt by way of a side strand in such a way that the residence time of the crosslinker in the homogenizing means is shorter than that of the polyaddition resin melt. This is particularly advisable when an equally long residence of polyaddition resin melt and crosslinker in the homogenizing means would lead to an excessive fraction of precrosslinked particles.

The apparatus envisaged for implementing the process of the invention comprises a Taylor reactor having an inlet region for the supply of the process materials for the preparation of a polyaddition resin melt and having an outlet for the delivery of the polyaddition resin melt. Further provided is a homogenizing means which comprises at least one first and one second inlet for supplying the polyaddition resin melt delivered by the Taylor reactor, and a crosslinker. The homogenizing means is further provided with an outlet via which the components melt—that is, the mixture of polyaddition resin melt and crosslinker—can be delivered to a cooling means and from there to a grinding means, one example of which is a classifier mill, in particular a horizontal impact classifier mill.

Interposed between the Taylor reactor and the homogenizing means there may be a devolatilizing means for stripping monomer residues and initiator disintegration products from the polyaddition resin melt. This is indispensable if the homogenizing means does not allow gas to be let off, as may be the case, for example, with static mixers. If the homogenizing means used comprises a devolatilizing extruder there is no need for the devolatilizing means.

One preferred embodiment of the apparatus of the invention comprises means for adding at least one additive to the Taylor reactor and/or to the homogenizing means. Said homogenizing means preferably takes the form of a static mixer or extruder to which at least the polyaddition resin melt and the crosslinker can be supplied—via a side strand where appropriate. Mixtures of substances can be supplied to the Taylor reactor and/or to the homogenizing means by way of mixing means, such as are described, for example, in German patent application DE 199 60 389 A1, column 4, line 55 to column 5, line 34.

The Taylor reactor preferably has a toroidal reaction volume which opens to an outlet region of the reactor. The Taylor reactor is provided with a rotor preferably mounted only at one of its end faces in such a way as to be rotatable about its central longitudinal axis. The mounted end face of the Taylor reactor is preferably located within the narrowest region of the reaction volume, which is also where the inlet region is provided. The reactor housing, the reactor wall and/or the rotor may be configured in such a way that the cross section of the toroidal reaction volume from the inlet region to the outlet region increases initially but at least over part of the length of the rotor the cross-sectional increase does not grow larger, as is described in German patent application DE 102 50 420.2, unpublished at the priority date of the present specification.

If in particularly preferred fashion the outlet region is provided above the unmounted end of the rotor and if in likewise particularly preferred fashion the outlet region broadens beyond the reaction volume in the direction of flow traversal or if the outlet region remains the same and subsequently tapers to a production outlet, then the formation of dead spaces, in which there will be no control over the residence times spent by the reaction product in the reactor, is almost completely avoided. Consequently, unwanted reactions due to excessive residence times in the reactor are effectively avoided.

Likewise for the purpose of avoiding dead spaces, the outlet region of the Taylor reactor is followed by the greatest diameter of a product outlet, which tapers in the direction of flow traversal by the polyaddition resin melt. If in likewise particularly preferred fashion the product outlet includes a pressure maintenance valve, a pressure can be built up in the Taylor reactor and, where appropriate, can be regulated so as to allow continuous discharge of the polyaddition resin melt.

The invention will now be described in detail with reference to the attached drawings, in which:

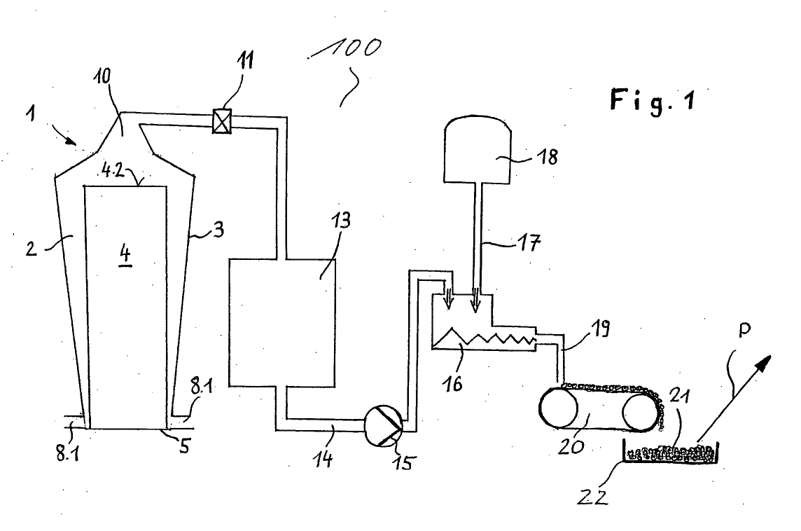

FIG. 1 shows, diagrammatically, apparatus according to the invention and

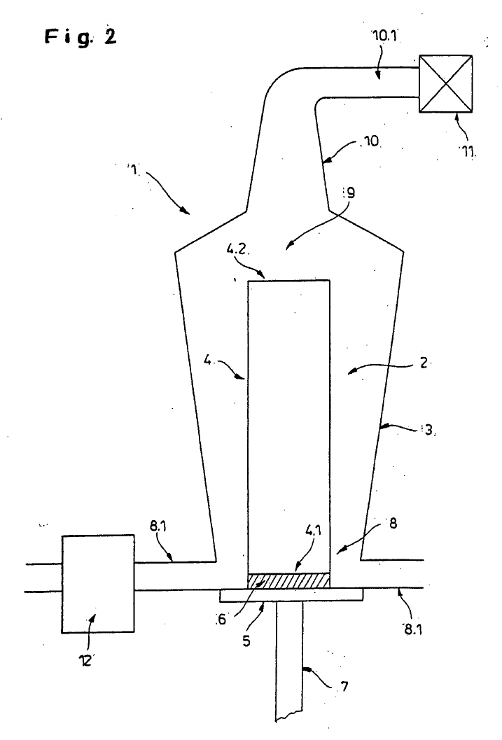

FIG. 2 shows a preferred embodiment of the Taylor reactor that forms part of the apparatus.

The apparatus designated as a whole by (100) in FIG. 1 and intended for implementing the process of the invention for producing powder coating materials comprises a Taylor reactor (1). The reactor has a toroidal reaction volume (2) which broadens in the direction of flow traversal and is defined by a reactor housing or reactor wall (3), a rotor (4) and a reactor floor (5). In the region of the reactor floor (5), i.e., in the narrowest region of the reaction volume, there are feed ports (8.1) opening into the reaction volume (2) for the process materials. In the course of flow traversal through the reaction volume (2) the process materials, advancing upward, are converted into the product, which is taken off via a product exit (10) disposed essentially above the end face (4.2) of the rotor (4). Inserted in the product exit (10) is a pressure maintenance valve (11) which maintains the pressure in the reactor preferably between about 1 and 10 bar, typically from 2 to 4 bar. After the product has passed through the pressure maintenance valve (11) it enters, in the embodiment example depicted in FIG. 1, into a letdown vessel (13), in which the prevailing pressure is atmospheric or, preferably, subatmospheric. The letdown vessel (13) serves as a devolatilizing means. The drop in pressure results in the escape of monomer residues which have not been converted in the Taylor reactor (1) and also disintegration products of initiators which were supplied to the Taylor reactor (1) through the feed ports (8.1), for example, for the polymerization of the monomers.

The letdown vessel (13) is preferably equipped, though not depicted in the drawing, with a nozzle system or spray system, so that letdown of the product conveyed under pressure from the Taylor reactor (1) via a nozzle into the vessel (13) is already accompanied by the escape of a large proportion of the volatile fractions from the melt and these volatiles can be removed in conventional manner by way of a vacuum system, which again is not depicted. An arrangement of this kind and a technique of this kind are known as a flash zone and a flash process, respectively. Devolatilizing means are conventional partial evaporators or strand devolatilizers.

From the letdown vessel (13) the polyaddition resin melt produced in the Taylor reactor is supplied via line (14) and a pump (15) inserted therein to a homogenizing means (16) which in the embodiment example depicted takes the form of a static mixer having two supply openings. Connected to the second supply opening of the homogenizing means (16) by a line (17) is a reservoir vessel (18) containing the crosslinker needed to form the components melt and also containing, where appropriate, additives in fluid form. In the homogenizing means (16) the polyaddition resin melt and the fluid crosslinker are mixed with one another.

If an extruder is used as homogenizing means (16) it is then possible, in a further, simplified form of the process, for the polymer melt to be devolatilized in the extruder (16). Consequently, letdown vessel (13) can be omitted or can be used simply as a buffer vessel.

The components melt is supplied via a delivery line (19) attached to the extruder to a cooling means (20), here shown diagrammatically as a cooling belt. The cooled and thus solidified components melt (21) is collected in a collecting container (22) from which it is supplied—as the arrow P is intended to symbolize—to a pulverizing means, which is not shown in the drawing but is generally a powder mill.

An essential feature of the process implemented by means of the apparatus according to the invention is that the reaction product delivered by the Taylor reactor (1), said product typically having a temperature of about 140° C., is supplied at approximately this temperature, in the associated liquid melt form, to the homogenizing means (16). Since the crosslinker is supplied likewise in fluid form, i.e., in particular, in powder or liquid melt form, mixing in the homogenizing means to a high degree of homogenization can take place in so short a time as to rule out completely, or almost completely, crosslinking reactions during passage through the homogenizing means (16). The solidified components melt (21) delivered by the cooling means (20) therefore contains only negligible fractions of precrosslinked particles.

One preferred embodiment of a Taylor reactor (1) suitable for the apparatus according to the invention and for implementing the process of the invention is shown in detail in FIG. 2. It comprises an outer reactor wall or reactor housing (3) which—as already mentioned above—forms a toroidal reaction volume (2) together with the reactor floor (5) and the rotor (4). The lower region of the reaction volume (2), which at the same time is the narrowest region, forms the inlet region (8) into which the side feed ports (8.1) open. Integrated into the feed port, and depicted on the left in FIG. 2, is a mixing means (12), so that two or more components can be supplied in premixed state by way of this feed port (8.1).

The rotor (4) is mounted rotatably only at its lower end (4.1), the end located in the inlet region (8). Rotational drive is served by a drive shaft (7) coupled to the rotor. The reaction volume is sealed by way of a face seal (6), which is disposed between the rotor (4) and the reactor floor (5). On its side (4.2) opposite the rotatably mounted end (4.1) the rotor (4) is not mounted, so that in the region of the upper end face of the rotor (4) the toroidal reaction volume becomes an outlet region (9) and does so in such a way that there are substantially no dead spaces. This outlet region (9) tapers to a product exit (10) which, again narrowing conically, opens into a line (10.1) which leads to the pressure maintenance valve (11).

In one particularly preferred embodiment the reactor housing, reactor wall (3) and/or rotor (4) is or are configured in such a way that the cross section of the toroidal reaction volume (2) from the inlet region (8) to the outlet region (9) increases initially but at least over part of the length of the rotor (4) the cross-sectional increase does not grow larger, as is described in German patent application DE 102 50 420.2, unpublished at the priority date of the present specification.

The polyaddition resin melts are preferably the melts of polyurethanes, polyepoxides, and addition (co)polymers of olefinically unsaturated monomers, especially copolymers of olefinically unsaturated monomers.

The copolymers of olefinically unsaturated monomers may have a random or alternating distribution of the copolymerized monomers or may be block copolymers or graft copolymers. They may be prepared by free-radical, anionic or cationic, in particular free-radical, (co)polymerization, block copolymerization or graft copolymerization of at least one olefinically unsaturated monomer.

Examples of suitable olefinically unsaturated monomers are cyclic and acyclic, optionally functionalized monoolefins and diolefins, vinylaromatic compounds, vinyl ethers, vinyl esters, vinylamides, vinyl halides, allyl ethers and allyl esters, acrylic acid and methacrylic acid and their esters, amides, and nitriles, and maleic acid, fumaric acid, itaconic acid and their esters, amides, imides, and anhydrides.

Examples of suitable monoolefins are ethylene, propylene, 1-butene, 1-pentene, 1-hexene, 1-heptene, 1-octene, cyclobutene, cyclopentene, dicyclopentene, and cyclohexene.

Examples of suitable diolefins are butadiene, isoprene, cyclopentadiene, and cyclohexadiene.

Examples of suitable vinylaromatic compounds are styrene, alpha-methylstyrene, 2-, 3-, and 4-chloro-, -methyl-, -ethyl-, -propyl-, and -butyl- (including tert-butyl-)substituted styrene and alpha-methylstyrene.

An example of a suitable vinyl compound or of a functionalized olefin is vinylcyclohexanediol.

Examples of suitable vinyl ethers are methyl, ethyl, propyl, butyl and pentyl vinyl ether, allyl monopropoxylate, and trimethylolpropane monoallyl, diallyl, and triallyl ether.

Examples of suitable vinyl esters are vinyl acetate and vinyl propionate and also the vinyl esters of Versatic acid and other quaternary acids.

Examples of suitable vinylamides are N-methyl-, N,N-dimethyl-, N-ethyl-, N-propyl-, N-butyl-, N-amyl-, N-cyclopentyl-, and N-cyclohexylvinylamide and also N-vinylpyrrolidone and N-vinyl-epsilon-caprolactam.

Examples of suitable vinyl halides are vinyl fluoride and vinyl chloride.

Examples of suitable vinylidene halides are vinylidene fluoride and vinylidene chloride.

Examples of suitable allyl ethers are methyl, ethyl, propyl, butyl, pentyl, phenyl, and glycidyl monoallyl ether.

Examples of suitable allyl esters are allyl acetate and allyl propionate.

Examples of suitable esters of acrylic acid and methacrylic acid are methyl, ethyl, propyl, n-butyl, isobutyl, n-pentyl, n-hexyl, 2-ethylhexyl, isodecyl, decyl, cyclohexyl, t-butylcyclohexyl, norbornyl, isobornyl, 2- and 3-hydroxypropyl, 4-hydroxybutyl, and glycidyl(meth)acrylate and the mono(meth)acrylates of trimethylolpropane and of pentaerythritol. Also suitable are the di-, tri-, and tetra(meth)acrylates of ethylene glycol, di-, tri-, and tetraethylene glycol, propylene glycol, dipropylene glycol, butylene glycol, dibutylene glycol, glycerol, trimethylolpropane, and pentaerythritol. They, however, are used not alone but rather always in minor amounts together with the monofunctional monomers.

Examples of suitable amides of acrylic and methacrylic acid are (meth)acrylamide and also N-methyl-, N,N-dimethyl-, N-ethyl-, N-propyl-, N-butyl-, N-amyl-, N-cyclopentyl-, and N-cyclohexyl(meth)acrylamide.

Examples of suitable nitriles are acrylonitrile and methacrylonitrile.

Examples of suitable esters, amides, imides, and anhydrides of maleic acid, fumaric acid, and itaconic acid are dimethyl, diethyl, dipropyl, and dibutyl maleate, fumarate and itaconate, maleamide, fumaramide, and itaconamide, N,N′-dimethyl-, N,N,N′,N′-tetramethyl-, N,N′-diethyl-, N,N′-dipropyl-, N,N′-dibutyl-, N,N′-diamyl, N,N′-dicyclopentyl-, and N,N′-dicyclohexyl-maleamide, -fumaramide, and -itaconamide, maleimide, fumarimide, and itaconimide, N-methyl-, N-ethyl-, N-propyl-, N-butyl-, N-amyl-, N-cyclopentyl-, and N-cyclohexyl-maleimide-, -fumarimide, and -itaconimide, and maleic, fumaric, and itaconic anhydride.

The olefinically unsaturated monomers are preferably selected so as to give (meth)acrylate (co)polymers, preferably (meth)acrylate copolymers, and more preferably (meth)acrylate copolymers, and especially methacrylate copolymers.

The above-described monomers can be polymerized free-radically, cationically or anionically. They are advantageously polymerized free-radically. For this purpose it is possible to use the conventional inorganic free-radical initiators or other initiators such as hydrogen peroxide or potassium peroxodisulfate or the conventional organic free-radical initiators or other initiators such as dialkyl peroxides, e.g., di-tert-butyl peroxide, di-tert-amyl peroxide, and dicumyl peroxide; hydroperoxides, e.g., cumene hydroperoxide and tert-butyl hydroperoxide; peresters, e.g., tert-butyl perbenzoate, tert-butyl perpivalate, tert-butyl per-3,5,5-trimethylhexanoate, and tert-butyl per-2-ethylhexanoate; bisazo compounds such as azobisisobutyrolnitrile; or C—C initiators such as 2,3-dimethyl-2,3-diphenyl-butane or -hexane. Also suitable, however, is styrene, which initiates the polymerization thermally even without free-radical initiators.

For the preparation of the polyaddition resin melts at least one of the above-described monomers is metered via a side feed port (8.1) into the inlet region (8) of the Taylor reactor (1) of the invention. Preferably at least one of the above-described free-radical initiators or other initiators is metered, preferably together with at least one monomer, via another side feed port.

The monomer or monomers is or are polymerized in the toroidal reaction volume (2) at least partly under the conditions of Taylor flow. The resultant liquid polyaddition resin is conveyed from the toroidal reaction volume (2) into the outlet region (10) and from there into the product exit (10.1) and is discharged via the pressure maintenance valve (11).

The conditions for Taylor flow are met preferably in part of the toroidal reaction volume (2) or in the whole of the toroidal reaction volume (2), particularly in the whole of the toroidal reaction volume (2). Both laminar and turbulent Taylor vortex flows may come about, or intermediate forms from laminar to turbulent. The temperature of the reaction medium may vary widely and is guided in particular by the monomer having the lowest decomposition temperature, by the temperature at which depolymerization sets in, and by the reactivity of the monomer or monomers and of the initiators. The polymerization is conducted preferably at temperatures from 100 to 200° C., more preferably from 130 to 180° C., and in particular from 150 to 180° C.

The polymerization can be conducted under pressure. The pressure is preferably from 1 to 100 bar, more preferably from 1 to 25 bar, and in particular from 1 to 10 bar.

The passage time may vary widely and is guided in particular by the reactivity of the monomers and by the size, in particular the length, of the Taylor reactor of the invention. The passage time is preferably from 10 minutes to 2 hours, in particular from 20 minutes to 1 hour.

It is a very particular advantage that the conversion of the monomers is >70 mol %. Surprisingly it is possible without problems to achieve conversions >80, preferably >90, more preferably >95, very preferably >98, and in particular >98.5 mol %. In the course of these conversions, as is normal in the case of polymerization in bulk, the kinematic viscosity ν may increase by at least ten times, in particular by at least one hundred times.

The molecular weight of the polyaddition resins may vary widely and is limited essentially only by the maximum kinematic viscosity ν at which the Taylor reactor (1) is able to maintain the conditions of Taylor flow at least in some regions. The number-average molecular weights of the polyaddition resins prepared in a procedure in accordance with the invention is preferably from 800 to 50,000, more preferably from 1000 to 25,000, and in particular from 1000 to 10,000 daltons. The molecular weight polydispersity is preferably <10, in particular <8.

### EXAMPLE

The Production of a Powder Coating Material

The Taylor reactor (1) used had a toroidal volume (2) of 2.3 liters and a gap width in the lower region of 8 mm and in the upper part of 32 mm. The rotor (4) was 567 mm in total length. As viewed from the inlet region (8), the gap width of the toroidal reaction volume (2) rose from 8 mm to 32 mm over a 222 mm section of the rotor (4). Over the remaining section of 345 mm the gap width remained constant at 32 mm up to the outlet region. All parts of the equipment were heatable via a jacket (3). This jacket was subdivided into two heating zones in the reactor section, the lower part of that section being set at a temperature of 170° C. and the upper part at a temperature of 140° C. in the heating jacket by way of the thermal oil heating medium. The outlet section (10) was likewise heated via the heating jacket at 140°.

The Taylor reactor (1) was filled completely with the organic solvent Shellsol A in order to build up the necessary polymerization pressure by way of the pressure maintenance valve (11) and to set the polymerization temperature. The reactor jacket temperature was set to 170° C. in the lower region. The rotor (4) was started up before the feed streams were metered in (8.1), with the rotary speed being 500 min⁻¹. The organic solvent was subsequently displaced by the monomer feed and initiator feed. The initial fraction of copolymer was discarded.

The copolymerization was carried out using two feeds I and II of the composition set out below.

TABLE 1
Physical composition of feeds I and II

| | Substance | Fraction |
|---|---|---|
| Feed I | Styrene | 24.2% |
| | methyl methacrylate | 29.1% |
| | glycidyl methacrylate | 27.1% |
| Feed II | tert-butylcyclohexyl acrylate | 16.5% |
| | mercaptoethanol | 0.2% |
| | di-tert-butyl peroxide | 0.7% |
| | di-tert-amyl peroxide | 2.2% |

Feed I was mixed with a mass flow of 92.8 g/min and feed II with a mass flow of 22.6 g/min. The resulting mixture I+II was metered into the inlet region (8) with a mass flow of 115.4 g/min. Mixing and metering were carried out via computer-controlled reciprocating pumps. During the polymerization the pressure was regulated by hand at the pressure maintenance valve.

The copolymer obtained after the initial fraction was discharged continuously via the pressure maintenance valve (11) and was passed through an insulated pipe into a heated letdown vessel (13) (buffer vessel). The number-average molecular weight of the copolymer was 2768 daltons and its mass-average molecular weight was 8351 daltons. The molecular weight polydispersity, accordingly, was 3.0. The conversion, determined by means of gas chromatography, was 98.8%. The melt viscosity of the polymer at 170° C. was 3.2 Pas.

The small fractions of residual monomers and initiator disintegration products were removed from the letdown vessel (13) by means of reduced pressure.

By means of a gear pump (15), the polymer melt was pumped at 6.9 kg/h into a static mixer (16). In parallel thereto a mixture of crosslinker and additives (see Table 2) was metered likewise by means of a gear pump from a second vessel (17), which was heated at 135° C., via line (17) at 2.5 kg/h into the static mixer.

TABLE 2
Physical composition of the mixture of
crosslinker and additives

| Raw material | Weight fraction |
|---|---|
| Dodecanedioic acid | 87.89% |
| Commercial, triazine-based UV absorber | 7.45% |
| Commercial free-radical scavenger based | 3.73% |
| on sterically hindered amine (HALS) | |
| Commercial devolatilizer (containing | 2.24% |
| benzoin) | |
| Commercial antiyellowing agent | 7.45% |
| Commercial, phosphite-based | 0.92% |
| antiyellowing agent | |
| Commercial, polysiloxane-based leveling | 1.12% |
| agent | |

The static mixer (16) consisted of a steel tube with a packing of Sulzer SMX mixing elements, the diameter of the mixing elements being 8 mm and the overall length of the packing being 120 mm.

Following its discharge (19) from the static mixer the melt-homogenized mixture (21) was immediately cooled on the cooling means (20), precomminuted, and collected in the vessel (22).

The coarse material was subsequently ground to a fineness of X50 ˜40-60 μm on a laboratory comminution mill (P).

The powder clearcoat material thus obtained was applied by means of corona powder coating gun to steel panels which had been precoated with a cathodically deposited and baked electrocoat, an aqueous surfacer (baked at 155° C. for 20 minutes), and a commercial aqueous basecoat material (predried at 80° C. for 10 minutes) and the resulting coating system was baked at 150° C. for 30 minutes. The powder clearcoat obtained in this way had a high gloss of 91° and a very good solvent resistance (200 double rubs in the methyl ethyl ketone test).

1. A process for producing powder coating materials, comprising the following steps:
preparing a polyaddition resin melt using a Taylor reactor (1) at a temperature above the melting temperature of the polyaddition resin;
supplying the polyaddition resin melt to a homogenizing means (16);
adding a crosslinker to the homogenizing means (16) to prepare a components melt;
cooling the components melt on a cooling means (20) for solidification to the end product;
supplying the end product to a pulverizing means P.

2. The process as claimed in claim 1, wherein the polyaddition resin melt is devolatilized before its entry into the homogenization means (16).

3. The process of claim 1, wherein the crosslinker is added in powder or liquid melt form.

4. The process of claim 1, wherein the crosslinker is supplied in parallel with the polyaddition resin melt to the homogenizing means (16).

5. The process of claim 1, wherein the crosslinker is supplied to the polyaddition resin melt via a side strand of the homogenizing means.

6. The process of claim 1, wherein homogenization takes place statically.

7. The process of claim 1, wherein homogenization takes place dynamically.

8. The process of claim 1, wherein additives are supplied to at least one of the crosslinker and the polyaddition resin melt.

9. The process of claim 1, wherein the polyaddition resins are selected from the group consisting of polyurethanes, polyepoxides and addition (co)polymers of olefinically unsaturated monomers.

10. Apparatus for implementing a process as claimed in claim 1,
comprising a Taylor reactor (1) with an inlet region (8) for supplying the process materials to prepare a polyaddition resin melt and having an outlet (10) for delivering the polyaddition resin melt,
further comprising a homogenizing means (16) which comprises at least one first and second inlets for supplying the polyaddition resin melt delivered by the Taylor reactor, and the crosslinker, and also comprising an outlet via which a product is delivered by the homogenizing means (16).

11. The apparatus of claim 10, wherein a devolatilizing means (13) is interposed in the supply line from the Taylor reactor (1) to the homogenizing means (16).

12. The apparatus of claim 11, wherein the homogenizing means (16) is an extruder having at least two feed openings.

13. The apparatus of claim 10, wherein the homogenizing means (16) is a devolatilizing extruder having at least two feed openings.

14. The apparatus of claim 11, wherein the homogenizing means (16) is a static mixer.

15. The apparatus, of claim 11 wherein the devolatilizing means comprises a letdown vessel.

16. The apparatus of claim 15, further comprising a pressure maintenance valve (11) upstream of the letdown vessel (13).

17. The apparatus of claim 10, wherein means for adding at least one additive to at least one of the Taylor reactor (1) and the homogenizing means (16) are provided.

18. The apparatus of claim 10, wherein the Taylor reactor (1) has a toroidal reaction volume (2) which opens to an outlet region (9).

19. The apparatus of claim 18, wherein the Taylor reactor (1) comprises a rotor (4) which is mounted rotatably at one of its end faces.

20. The apparatus of claim 10, wherein the inlet range (8) is provided in the narrowest region of the reaction volume (2) of the Taylor reactor (1).

21. The apparatus of claim 10, wherein the outlet region (9) is provided above the unmounted end (4.2) of the rotor (4).

22. The apparatus of claim 10, wherein at least one of the reactor housing, reactor wall (3) and rotor (4) is or are configured in such a way that the cross section of the toroidal reaction volume (2) from the inlet region (8) to the outlet region (9) increases initially but at least over part of the length of the rotor (4) and the cross-sectional increase does not grow larger.

23. The apparatus of claim 21, wherein the outlet region (9) broadens or stays the same beyond the reaction volume (2) in the direction of flow traversal and subsequently tapers to a product outlet (10).

24. The apparatus of claim 10, wherein the greatest diameter of the product outlet (10) follows the outlet region (9) and said product outlet (10) tapers in the direction of flow traversal.
